(19) United States
(12) Patent Application Publication
(10) Pub. No.: US 2025/0200694 A1
(43) Pub. Date: Jun. 19, 2025

(54) IMAGE PROCESSING METHOD AND APPARATUS, SYSTEM, AND STORAGE MEDIUM

(71) Applicant: Beijing Zitiao Network Technology Co., Ltd., Haidian District, Beijing (CN)

(72) Inventors: Chun LIU, Beijing (CN); Zhenpeng LI, Beijing (CN)

(21) Appl. No.: 18/856,451

(22) PCT Filed: Mar. 29, 2023
(86) PCT No.: PCT/CN2023/084719

§ 371 Date: Oct. 11, 2024

(30) Foreign Application Priority Data
Apr. 11, 2022 (CN) 202210373968.3

(51) Int. Cl. G06T 1/20

(52) U.S. Cl. CPC G06T 1/20

(57) ABSTRACT

The present disclosure relates to an image processing method and apparatus, a device, a storage medium, and a program product. The method includes: acquiring an image to be processed; inputting the image to be processed into an algorithm rendering composite system to obtain a processed image, wherein the algorithm rendering composite system is obtained by adding a rendering node to an algorithm system, and the rendering node is configured to render an image input to the rendering node; and sending the processed image to a rendering system to render the processed image by the rendering system.

### CROSS-REFERENCE TO RELATED APPLICATIONS

The present application is based on the application with a CN application number of 202210373968.3 and the filing date of Apr. 11, 2022, and claims its priority. The disclosure of this CN application as a whole is incorporated into the present application herein by reference.

### TECHNICAL FIELD

The invention relates to the technical field of data processing, in particular to an image processing method, apparatus, system and storage medium.

### BACKGROUND

In the related technology, when shooting short videos and rendering effects, the algorithm system first executes all the algorithms, and then the rendering system makes one-time rendering based on the algorithm results.

### SUMMARY

In a first aspect, an embodiment of the present disclosure provides an image processing method, which includes:
acquiring an image to be processed;
inputting the image to be processed into an algorithm rendering composite system to obtain a processed image, wherein the algorithm rendering composite system is obtained by adding a rendering node to an algorithm system, and the rendering node is configured to render an image input to the rendering node; and
sending the processed image to a rendering system to render the processed image by the rendering system.

In a second aspect, an embodiment of the present disclosure provides an image processing apparatus, which includes:
an image acquisition module for acquiring an image to be processed;
an image processing module for inputting the image to be processed into an algorithm rendering composite system to obtain a processed image, wherein the algorithm rendering composite system is obtained by adding a rendering node to an algorithm system, and the rendering node is configured to render an image input to the rendering node;
an image rendering module for sending the processed image to a rendering system to render the processed image by the rendering system.

In a third aspect, an embodiment of the present disclosure provides an image processing apparatus, and the electronic device includes:
a memory; and
a processor coupled to the memory, the processor configured to perform the image processing method according to any one of the above first aspects based on instructions stored in the memory.

In a fourth aspect, an embodiment of the present disclosure provides an image processing system, including:
any of the aforementioned image processing apparatuses; and
an algorithm rendering composite system including an algorithm node and a rendering node.

In a fifth aspect, an embodiment of the present disclosure provides a computer-readable storage medium on which a computer program is stored, which, when executed by a processor, implements the image processing method according to any one of the first aspects.

In a sixth aspect, an embodiment of the present disclosure provides a computer program product including a computer program or instructions which, when executed by a processor, implement the image processing method according to any one of the first aspects.

In a seventh aspect, an embodiment of the present disclosure provides a computer program, including:
instructions that, when executed by a processor, cause the processor to perform any of the aforementioned image processing methods.

### BRIEF DESCRIPTION OF THE DRAWINGS

The above and other features, advantages, and aspects of embodiments of the present disclosure will become more apparent by referring to the following detailed description when taken in combination with the accompanying drawings. Throughout the drawings, the same or similar reference signs refer to the same or similar elements. It should be understood that the drawings are schematic and that the originals and elements are not necessarily drawn to scale.

FIG. 1 is a flow diagram of an image processing method in an embodiment of the present disclosure;

FIG. 2 is a timing diagram of an algorithm rendering composite system and a rendering system in an embodiment of the present disclosure;

FIG. 3 is a rendering node implementation class diagram in an embodiment of the present disclosure;

FIG. 4 is a flow diagram of an algorithm life cycle in an embodiment of the present disclosure;

FIG. 5 is a schematic structural diagram of an image processing apparatus in an embodiment of the present disclosure;

FIG. 6 is a schematic structural diagram of an electronic device in an embodiment of the present disclosure.

### DETAILED DESCRIPTION

Embodiments of the present disclosure will be described in more detail below with reference to the accompanying drawings. Although certain embodiments of the present disclosure are shown in the drawings, it should be understood that the present disclosure may be embodied in various forms and should not be construed as limited to the embodiments set forth herein, but rather these embodiments are provided for a more complete and thorough understanding of the present disclosure. It should be understood that the drawings and embodiments of the present disclosure are for illustration purposes only and are not intended to limit the scope of the disclosure.

It should be understood that the various steps recited in the method embodiments of the present disclosure may be performed in a different order, and/or performed in parallel. Moreover, the method embodiments may include additional steps and/or omit performing the illustrated steps. The scope of the present disclosure is not limited in this respect.

The term “include” and variations thereof as used herein are intended to be open-ended, i.e., “include but not limited to”. The term “based on” is “based at least in part on”. The term “one embodiment” means “at least one embodiment”; the term “another embodiment” means “at least one additional embodiment”; the term “some embodiments” means “at least some embodiments”. Relevant definitions for other terms will be given in the following description.

It should be noted that the terms “first”, “second”, and the like in the present disclosure are only used for distinguishing different devices, modules or units, and are not used for limiting the order of functions performed by the devices, modules or units or interdependence thereof.

It is noted that references to “a” or “a plurality of” mentioned in the present disclosure are intended to be illustrative rather than limiting, and those skilled in the art will appreciate that unless otherwise clearly indicated in the context, they should be understood as “one or more”.

The names of messages or information exchanged between devices in the embodiments of the present disclosure are for illustrative purposes only, and are not intended to limit the scope of the messages or information.

In short video shooting and effects rendering, with the continuous enrichment and upgrading of effects gameplay, in some usage scenarios, algorithms and rendering need to be executed alternately in the process of processing each frame of camera picture, instead of the traditional way that the algorithm system executes all the algorithms first, and then the rendering system makes one-time rendering based on the algorithm results. The processing flow of each frame of camera picture is changed to first execute algorithm A, then execute rendering A, then execute algorithm B, and then execute rendering B.

For example, in order to achieve the stylization effect of GAN (Generative Adversarial Networks), it is necessary to run a face recognition algorithm and a GAN algorithm first, and then map, render and transform the image processed by the algorithms through a Graphics Processing Unit (GPU) so as to fuse the image generated based on the Gan algorithm with the original image, and then run the face recognition algorithm again and add beauty and other effects. Another example is: in the Matting algorithm of portrait segmentation, a GPU is used to render and extract the portrait, then the GAN algorithm is run, and then the GPU is used to map and render. Another example is: for the green screen video game, after the video frame is rendered and displayed on the screen, the algorithm is run and rendering is performed based on the video selected by the user.

The embodiment of the present disclosure provides an image processing method. A rendering node is arranged in an algorithm system, and part of the rendering processing is performed by the rendering node, wherein the rendering processing is interspersed among a plurality of algorithms, so as to improve the performance of the device. Next, the image processing method proposed by the embodiment of this application will be introduced in detail with the attached drawings.

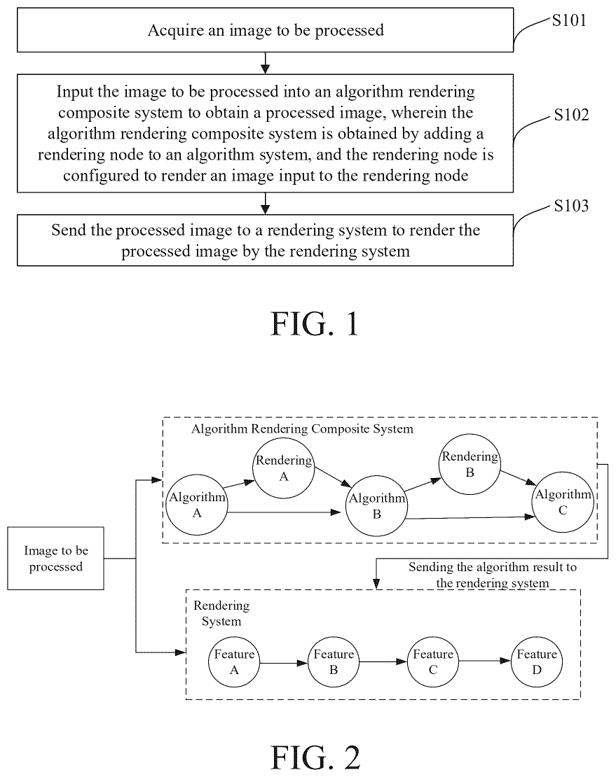

FIG. 1 is a flow diagram of an image processing method in an embodiment of the present disclosure. This embodiment can be applied to the case of effect rendering of video. This method can be executed by an image processing apparatus, which can be implemented in at least one of software or hardware, and can be configured in an electronic device. The image processing method provided by the embodiment of the present disclosure can be applied to shooting effects scenes and other algorithm scenes.

For example, the electronic device can be a mobile terminal, a fixed terminal or a portable terminal, such as a mobile phone, a site, a unit, a device, a multimedia computer, a multimedia tablet, an Internet node, a communicator, a desktop computer, a laptop computer, a notebook computer, a netbook computer, a tablet computer, a personal communication system (PCS) device, a personal navigation device, a personal digital assistant (PDA), an audio/video player, a digital camera/camcorder, a positioning device, a television receiver, a radio broadcast receiver, an e-book device, a game device or any combination thereof, including accessories and peripherals of these devices or any combination thereof.

For another example, the electronic device can be a server, wherein the server can be a physical server or a cloud server, and the server can be a server or a server cluster.

As shown in FIG. 1, the image processing method provided by the embodiment of the present disclosure mainly includes the following steps.

In step S101, an image to be processed is acquired.

The image to be processed can be understood as an image for which an algorithm needs to be run or rendering needs to be performed. The image to be processed may be an image frame in an image stream collected by a camera of the terminal device or an image texture uploaded by a user and received by the terminal device. In this embodiment, the image to be processed is only described, but not limited.

In step S102, the image to be processed is input into an algorithm rendering composite system to obtain a processed image, wherein the algorithm rendering composite system is obtained by adding a rendering node to an algorithm system, and the rendering node is configured to render an image input to the rendering node.

In this embodiment, an independent rendering engine is embedded in the algorithm system to abstract the intermediate rendering steps in the algorithm-rendering-algorithm process into an algorithm type node for rendering, namely a rendering node. In this way, the existing algorithm system is upgraded to an algorithm rendering composite system, which has the processing ability of the original algorithm and the rendering ability.

Based on the above technical solution, more complex and diversified effects rendering props can be realized, and more algorithm gameplay online can be supported. For example: patterned national style effects, etc.

Specifically, the operation that the rendering node renders the image input to the rendering node is executed by the GPU.

In this embodiment, the rendering operation of the rendering node is executed by the GPU, which reduces the dependence of the graphics card on the CPU and improves the performance of the device.

Specifically, the algorithm rendering composite system includes an algorithm node(s) and the rendering node(s) connected according to a set relationship, and the set relationship is determined by a graph configuration and includes a sequential dependency relationship between the algorithm node and the rendering.

Specifically, in this embodiment, the rendering node can be used in series with the algorithm node or in parallel with the CPU algorithm. In this embodiment, the relationship between the algorithm node and the rendering node is not limited.

In this embodiment, an algorithm operation graph can be arbitrarily organized by graph configuration, that is, the dependency relationship between the algorithm node and the rendering node can be determined by graph configuration. In this way, the dependency relationship between various nodes in the algorithm rendering composite system can be modified by graph configuration, so that the image processing method can be conveniently applied to a plurality of effects scenes.

Further, the algorithm node is used to run a corresponding algorithm on the image input to the algorithm node, and the operation that the algorithm node runs the corresponding algorithm on the image input to the algorithm node is executed by a central processing unit (CPU).

In this embodiment, when the algorithm node in the algorithm rendering composite system runs the related algorithm, it is executed by the CPU, and the rendering performed by the rendering node is executed by the GPU, which can improve the performance of the device and avoid the overhead of the device performance.

In step S103, the processed image is sent to a rendering system to render the processed image by the rendering system.

Specifically, a rendering engine and several rendering sub-nodes are embedded in the algorithm system, and the algorithm operation graph can be arbitrarily organized through graph configuration. As shown in FIG. 2, the image to be processed passes through algorithm node A, rendering node A, algorithm node B, rendering node B and algorithm node C in turn. By adding rendering nodes to the algorithm system, the algorithm system is upgraded to an algorithm rendering composite system. In addition to executing the conventional CPU algorithm nodes, the algorithm rendering composite system will also execute some GPU rendering nodes alternately. The sequential dependency relationship between the GPU rendering nodes and the CPU algorithm nodes can be determined by graph configuration.

Further, the rendering node is used to render the image input to the rendering node, and then convert a rendered image texture into an algorithm representation, and send the algorithm representation to an algorithm node connected with the rendering node or to a rendering node.

Specifically, the output content of the rendering node is usually an image texture. In some embodiments, the image texture is encapsulated in the form of an algorithm result and sent to a subsequent algorithm node or a rendering node, so as to perform the corresponding operation, realize the conversion of GPU images to CPU data, and improve the adaptability of the device.

In a possible embodiment, the algorithm node and the rendering node can be executed in series; and/or the algorithm node and the rendering node can be executed in parallel by multiple threads.

Specifically, the algorithm rendering composite system and the rendering system are independent of each other, and the business can use only the algorithm rendering composite system or mix it with other rendering systems. The algorithm rendering composite system and the rendering system can be executed in series in order or in parallel by multiple threads. Inside the algorithm rendering composite system is an independent scheduling sequence.

The embodiment of the disclosure provides an image processing method, including: acquiring an image to be processed; inputting the image to be processed into an algorithm rendering composite system to obtain a processed image, wherein the algorithm rendering composite system is obtained by adding a rendering node to an algorithm system, and the rendering node is configured to render an image input to the rendering node; sending the processed image to a rendering system to render the processed image by the rendering system. According to the embodiments of the present disclosure, the rendering node is arranged in the algorithm system, and part of the rendering processing is executed by the rendering node, so as to realize the effect of alternately executing the algorithm and rendering, and improve the performance of the device.

In a possible embodiment, the rendering node is a node that defines an algorithm type for rendering, and the rendering node is configured for instantiating a plurality of subclasses.

In the algorithm rendering composite system, all algorithm instances will inherit from BachAlgorithmAbstract base class to realize their own subclasses to complete their own algorithm logic functions, and are provided with corresponding life cycle methods such as doInit/doExecte/doDestory. The corresponding rendering node defines a new algorithm type and subclass implementation. For example, the algorithm type that defines the rendering node is GPU_RENDER, and the GPU_RENDER node can instantiate a plurality of subclasses. In a possible embodiment, by way of parameter configuration, each node can realize different rendering operations, including but not limited to rendering portrait segmentation, rendering GAN effect, rendering beauty cosmetics and so on.

Further, the definitions of a rendering node mainly include: a node is configured to define a rendering node, where all contents are lowercase, and the config parameters of nodes can be configured, wherein intParam is configured to define int type parameters; floatParam is configured to define float type parameters; stringParam is configured to define string type parameters; links is configured to define the connection dependency of nodes.

In the algorithm rendering composite system, it is necessary to define the parameters of GPU_RENDER node, which is used to configure and analyze a rendering scene (such as AmazingFeature). This part of configuration is realized depending on the specific rendering engine and algorithm implementation, and can be based on the business side usage scenario and implementation. Here, the effects usage scenario is taken as an example.

GPU_RENDER node configuration example:

```
Bash
  {
    “name”: “gpu_render_0”,
    “type”: “gpu_render”,
    “config”: {
      “keymaps”: {
        “pathParam”: {
          “feature_path”: “Matting/”
          }
        }
    }
  }
```

Where in the configuration of GPU_RENDER node, a pathParam type parameter feature_path is added to point to a rendering effect (AmazingFeature) path in the prop package, and the GPU_RENDER algorithm will parse the resource path and perform GPU rendering operation to draw on the output image texture.

GPU_RENDER algorithm nodes, like other algorithms, can arbitrarily organize connection relationships through graph configuration, thus realizing a more complex algorithm-rendering process.

In a possible embodiment, the rendering node is dynamically registered in the algorithm system as an independent algorithm to form an algorithm rendering composite system.

In this embodiment, the rendering node is an algorithm instance, and the specific implementation details depend on the rendering engine and script configuration. In order to decouple and isolate from the algorithm node in the algorithm system, the algorithm of this rendering node is dynamically registered in the algorithm system as a plug-in to form an algorithm rendering composite system. That is, the rendering node is realized by the business layer, and different rendering can be realized according to different business usage methods.

In a possible embodiment, the specific process of rendering processing executed by the GPU is determined by a pre-configured rendering engine and rendering scene.

Furthermore, the implementation details of the rendering node can be migrated and expanded, including but not limited to a new rendering engine with effects, and can also be migrated to other rendering engines such as Unity for implementation, or even simple rendering instructions directly using GPU instructions, thus realizing the migration and expansion of the algorithm rendering composite system and making the algorithm rendering composite system more widely used.

A concrete example is described using a new engine based on effect is described. In actual use, different rendering engines can be replaced according to the business characteristics, and the details of the algorithm can be re-implemented and dynamically injected into the algorithm rendering composite system. The framework will automatically complete the unified scheduling, cascading and result distribution of the algorithm.

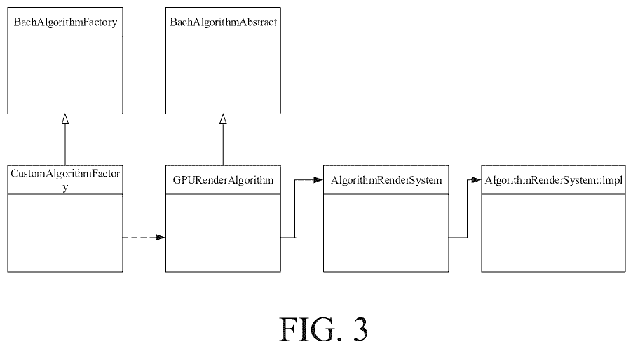

This embodiment provides a rendering node implementation class diagram, as shown in FIG. 3, CustomAlgorithmFactory: a custom Factory inherited from BachAlgorithmFactory (base class), which implements the construction and registration of GPURenderAlgorithm; GPURenderAlgorithm is inherited from BachAlgorithmAbstract, and implements the details of the rendering algorithm, which will depend on the rendering engine, and is encapsulated as AlgorithmRenderSystem here. AlgorithmRenderSystem is a rendering subsystem in the algorithm system, whose concrete implementation depends on the rendering engine of the business. In this embodiment, the new engine Amazer of Effect is taken as an example.

The algorithm GPURenderAlgorithm mainly completes the GPU rendering operation of rendering resources. In the effects scene, its responsibility is to render an AmazingFeature resource package path. This part mainly calls an API (Application Programming Interface) related to the new rendering engine Amazer to realize the corresponding algorithm life cycle method. The algorithm rendering composite system will schedule the algorithm as a whole during the execution process and realize the input and output according to the agreed protocol.

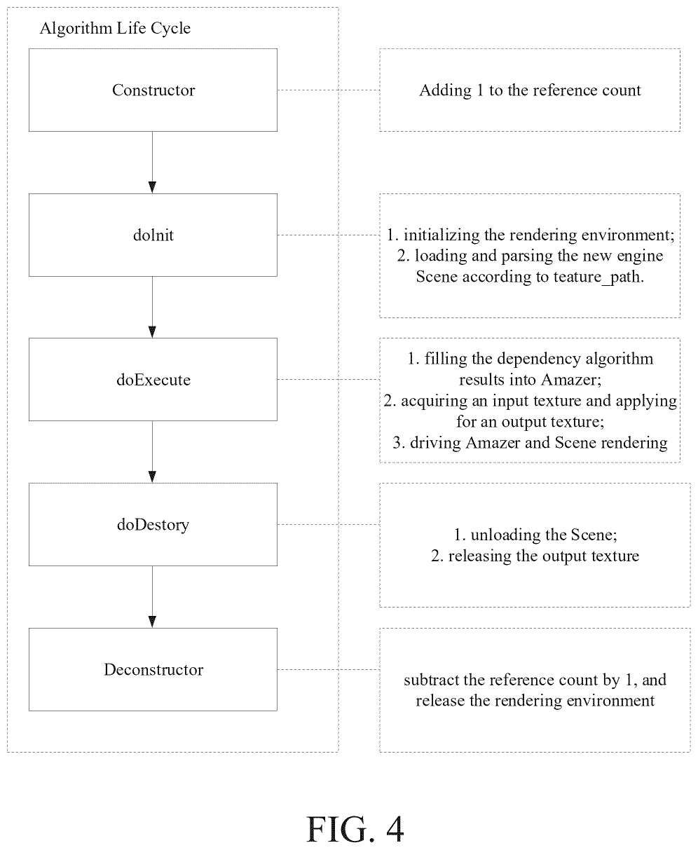

Further, as shown in FIG. 4, an algorithm life cycle mainly includes: constructor, dolnit, doExecute, doDestory and destructor. When building a function, a reference count is added by 1, and dolnit has two main functions: 1. initializing the rendering environment; 2. loading and parsing the new engine Scene according to teature_path. DoExecute has three main functions: 1. filling the dependency algorithm results into Amazer; 2. acquiring an input texture and applying for an output texture; 3. driving Amazer and Scene rendering. DoDestory has two main functions: 1. unloading the Scene; 2. releasing the output texture. When the function is destructed, the reference count is subtracted by 1, and the rendering environment is released.

According to the technical solution provided by this embodiment, only one algorithm rendering composite system and one rendering system are needed to process the image to be processed. Algorithm nodes are organized based on graph configuration in the existing algorithm system. An independent rendering engine is embedded in the algorithm system, which abstracts the intermediate rendering steps of the algorithm-rendering-algorithm process into a type of algorithm node (rendering node for short), and completes the specific GPU rendering operation in the implementation of the rendering node. In this way, the algorithm system is upgraded to an algorithm rendering composite system, which has the original algorithm processing ability and rendering ability.

The embodiment of the present disclosure provides an image processing method. The acquired image to be processed can be input into the algorithm rendering composite system, which meets the requirements of alternate execution of algorithms and rendering in the process of processing each frame of camera pictures, and at the same time solves the performance problem and flexibility problem of the existing algorithm architecture. Only one algorithm rendering composite system is needed, and the algorithm-rendering-algorithm-rendering process can be freely built based on graph configuration. At the same time, the advantage of multi-thread parallel acceleration can be obtained by using algorithm thread and rendering thread, and the performance and frame rate of the whole process can be improved.

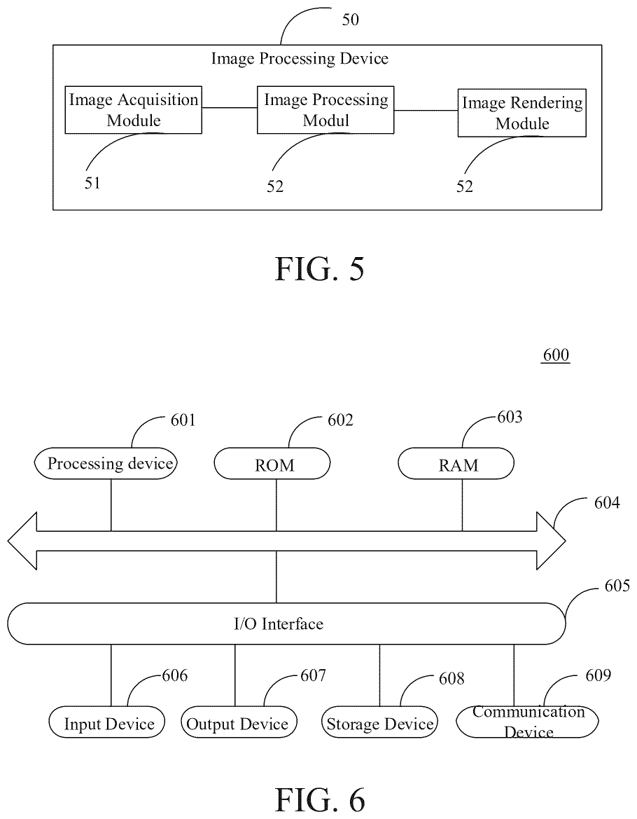

FIG. 5 is a schematic structural diagram of an image processing apparatus in an embodiment of the present disclosure. This embodiment can be applied to video shooting and effects rendering. The image processing apparatus can be implemented in at least one of software or hardware, and can be configured in electronic equipment. As shown in FIG. 5, the image processing apparatus provided by the embodiment of the present disclosure mainly includes an image acquisition module 51, an image processing module 52 and an image rendering module 53.

The image acquisition module 51 is for acquiring an image to be processed;
the image processing module 52 is for inputting the image to be processed into an algorithm rendering composite system to obtain a processed image, wherein the algorithm rendering composite system is obtained by adding a rendering node to an algorithm system, and the rendering node is configured to render an image input to the rendering node;
the image rendering module 53 for sending the processed image to a rendering system to render the processed image by the rendering system.

The embodiment of the present disclosure provides an image processing apparatus, which is used for executing the following processes: acquiring an image to be processed; inputting the image to be processed into an algorithm rendering composite system to obtain a processed image, wherein the algorithm rendering composite system is obtained by adding a rendering node to an algorithm system, and the rendering node is configured to render an image input to the rendering node; and sending the processed image to a rendering system to render the processed image by the rendering system. According to the embodiment of the present disclosure, the rendering node is set in the algorithm system, and part of the rendering processing is executed by the rendering node, so as to realize the effect of alternately executing the algorithm and rendering, and improve the performance of the device.

The present disclosure also provides an image processing system, including any one of the aforementioned image processing apparatuses; and an algorithm rendering composite system, including an algorithm node and a rendering node.

In a possible embodiment, the operation of the rendering node rendering the image input to the rendering node is executed by a Graphics Processing Unit (GPU)

In a possible embodiment, the algorithm rendering composite system includes an algorithm node and the rendering node connected according to a set relationship, and the set relationship is a sequential dependency relationship between the algorithm node and the rendering node determined by a graph configuration.

In a possible embodiment, the algorithm node is configured to run an algorithm on the image input to the algorithm node, and the operation of the algorithm node running an algorithm on the image input to the algorithm node is executed by a Central Processing Unit (CPU).

In a possible embodiment, the rendering node is configured to, after rendering the image input to the rendering node, convert a rendered image texture into an algorithm representation, and send the algorithm representation to an algorithm node connected with the rendering node or to a rendering node.

In a possible embodiment, the rendering node is a node that defines an algorithm type for rendering, and the rendering node is configured for instantiating a plurality of subclasses.

In a possible embodiment, the rendering node is dynamically registered into the algorithm system as an independent algorithm to form the algorithm rendering composite system.

In a possible embodiment, a specific process of rendering processing executed by the GPU is determined by a configured rendering engine.

In a possible embodiment, the image processing system further includes a rendering system.

The image processing apparatus and system provided by the embodiment of the present disclosure can execute the steps performed in the image processing method provided by the method embodiments of the present disclosure, and have the execution steps and beneficial effects, which are not described here.

FIG. 6 is a schematic structural diagram of an electronic device in an embodiment of the present disclosure. Referring now specifically to FIG. 6, which shows a schematic structural diagram suitable for implementing an electronic device 600 in an embodiment of the present disclosure. The electronic device 600 in the embodiment of the present disclosure may include, but is not limited to, a mobile terminal such as a mobile phone, a notebook computer, a digital broadcast receiver, a PDA (personal digital assistant), a PAD (tablet), a PMP (portable multimedia player), a vehicle terminal (e.g., a car navigation terminal), a wearable terminal device, and the like, and a fixed terminal such as a digital TV, a desktop computer, a smart home device, and the like. The terminal device shown in FIG. 6 is only an example, and should not bring any limitation to the functions and the scope of the application of the embodiment of the present disclosure.

As shown in FIG. 6, the terminal device 600 may include a processing device (e.g., a central processer, a graphics processor, etc.) 601 that may perform various appropriate actions and processes according to a program stored in a read-only memory (ROM) 602 or a program loaded from a storage device 608 into a random access memory (RAM) 603, so as to implement the image rending method in the embodiments of the present disclosure. In the RAM 603, various programs and data necessary for the operation of the terminal device 600 are also stored. The processing device 601, the ROM 602, and the RAM 603 are connected to each other via a bus 604. An input/output (I/O) interface 605 is also connected to the bus 604.

Generally, the following devices can be connected to the I/O interface 605: an input device 606 including, for example, a touch screen, touch pad, keyboard, mouse, camera, microphone, accelerometer, gyroscope, etc.; an output device 607 including, for example, a Liquid Crystal Display (LCD), speaker, vibrator, etc.; a storage device 608 including, for example, magnetic tape, hard disk, etc.; and a communication device 609. The communication device 609 may allow the terminal device 600 to communicate with other devices wirelessly or by wire to exchange data. While FIG. 6 illustrates a terminal device 600 having various means, it is to be understood that it is not required to implement or provide all of the means shown. More or fewer means may be alternatively implemented or provided.

In particular, the processes described above with reference to the flow diagrams may be implemented as computer software programs, according to the embodiment of the present disclosure. For example, an embodiment of the present disclosure includes a computer program product including a computer program carried on a non-transitory computer readable medium, the computer program containing program code for performing the method illustrated by the flow diagram, so as to implement the page jump method as described above. In such an embodiment, the computer program may be downloaded and installed from the network via the communication device 609, or installed from the storage device 608, or installed from the ROM 602. When executed by the processing device 601, the computer program performs the above-described functions defined in the method of the embodiments of the present disclosure.

It should be noted that the computer readable medium of the present disclosure may be a computer readable signal medium or a computer readable storage medium or any combination of the two. The computer readable storage medium may be, for example, but not limited to, an electronic, magnetic, optical, electromagnetic, infrared, or semiconductor system, apparatus, or device, or any combination of the foregoing. More specific examples of the computer readable storage medium may include, but are not limited to: an electrical connection having one or more wires, a portable computer diskette, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing. In the present disclosure, a computer readable storage medium may be any tangible medium that contains, or stores a program for use by or in combination with an instruction execution system, apparatus, or device. In contrast, in the present disclosure, a computer readable signal medium may include a data signal propagated in a baseband or as a part of a carrier wave, wherein a computer readable program code is carried therein. Such a propagated data signal may take a variety of forms, including, but not limited to, an electro-magnetic signal, an optical signal, or any suitable combination thereof. A computer-readable signal medium may be any computer readable medium other than a computer-readable storage medium and the computer-readable signal medium can communicate, propagate, or transport a program for use by or in combination with an instruction execution system, apparatus, or device. Program code embodied on a computer-readable medium may be transmitted using any appropriate medium, including but not limited to: electrical wires, optical cables, RF (radio frequency), etc., or any suitable combination thereof.

In some embodiments, the client and the server can communicate using any currently known or future-developed network protocol, such as HTTP (HyperText Transfer Protocol), and may be interconnected to digital data communication (e.g., a communication network) of any form or medium. Examples of communication networks include a local area network (“LAN”), a wide area network (“WAN”), the Internet (e.g., the Internet), and a peer-to-peer network (e.g., ad hoc peer-to-peer network), as well as any currently known or future developed network.

The computer readable medium may be included in the above-mentioned electronic device; or it may exist alone without being assembled into the electronic device.

The computer-readable medium carries one or more programs, which, when executed by the terminal device, cause the terminal device to: acquire an image to be processed; input the image to be processed into an algorithm rendering composite system to obtain a processed image, wherein the algorithm rendering composite system is obtained by adding a rendering node to an algorithm system, and the rendering node is configured to render an image input to the rendering node; and send the processed image to a rendering system to render the processed image by the rendering system.

Optionally, when the above one or more programs are executed by the terminal device, the terminal device can also execute other steps described in the above embodiment.

Computer program code for carrying out operations of the present disclosure may be written in one or more programming languages or a combination thereof, the programming languages include, but are not limited to an object oriented programming language such as Java, Smalltalk, C++, and also include conventional procedural programming languages, such as the “C” programming language, or similar programming languages. The program code can be executed entirely on the user's computer, partly on the user's computer, as an independent software package, partly on the user's computer and partly executed on a remote computer, or entirely on the remote computer or server. In the scenario involving a remote computer, the remote computer may be connected to the user's computer through any type of network, including a Local Area Network (LAN) or a Wide Area Network (WAN), or may be connected to an external computer (for example, through the Internet using an Internet service provider).

The flow diagrams and block diagrams in the figures illustrate the architecture, functionality, and operation that are possibly implemented by systems, methods and computer program products according to various embodiments of the present disclosure. In this regard, each block in the flow diagrams or block diagrams may represent a module, program segment, or portion of code, which includes one or more executable instructions for implementing the specified logical function(s). It should also be noted that, in some alternative implementations, the functions noted in the blocks may occur in an order different from that noted in the figures. For example, two blocks shown in succession may, in fact, be executed substantially concurrently, or they may sometimes be executed in a reverse order, depending upon the function involved. It will also be noted that each block of the block diagrams and/or flow diagrams, and a combination of blocks in the block diagrams and/or flow diagrams, can be implemented by special purpose hardware-based systems that perform the specified functions or operations, or combinations of special purpose hardware and computer instructions.

The units described in the embodiments of the present disclosure may be implemented by software or hardware. Wherein the name of a unit does not in some cases constitute a limitation on the unit itself. The functions described herein above may be performed, at least in part by one or more hardware logic components. For example, without limitation, exemplary types of hardware logic components that may be used include Field Programmable Gate Arrays (FPGAs), Application Specific Integrated Circuits (ASICs), Application Specific Standard Products (ASSPs), Systems on a Chip (SOCs), Complex Programmable Logic Devices (CPLDs), and so forth.

In the context of this disclosure, a machine readable medium may be a tangible medium that can contain, or store a program for use by or in combination with an instruction execution system, apparatus, or device. The machine readable medium may be a machine readable signal medium or a machine readable storage medium. The machine readable medium may include, but is not limited to, an electronic, magnetic, optical, electromagnetic, infrared, or semiconductor system, apparatus, or device, or any suitable combination thereof. More specific examples of the machine readable storage medium would include an electrical connection based on one or more wires, a portable computer diskette, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing.

According to one or more embodiments of the present disclosure, the present disclosure provides an image processing method, including: acquiring an image to be processed; inputting the image to be processed into an algorithm rendering composite system to obtain a processed image, wherein the algorithm rendering composite system is obtained by adding a rendering node to an algorithm system, and the rendering node is configured to render an image input to the rendering node; and sending the processed image to a rendering system to render the processed image by the rendering system.

According to one or more embodiments of the present disclosure, the present disclosure provides an image processing method, wherein the operation of the rendering node rendering the image input to the rendering node is executed by a Graphics Processing Unit (GPU).

According to one or more embodiments of the present disclosure, the present disclosure provides an image processing method, wherein the algorithm rendering composite system includes an algorithm node and the rendering node connected according to a set relationship, and the set relationship is a sequential dependency relationship between the algorithm node and the rendering node determined by a graph configuration.

According to one or more embodiments of the present disclosure, the present disclosure provides an image processing method, wherein the algorithm node is configured to run an algorithm on the image input to the algorithm node, and the operation of the algorithm node running an algorithm on the image input to the algorithm node is executed by a Central Processing Unit (CPU).

According to one or more embodiments of the present disclosure, the present disclosure provides an image processing method, wherein the rendering node is configured to, after rendering the image input to the rendering node, convert a rendered image texture into an algorithm representation, and send the algorithm representation to an algorithm node connected with the rendering node or to a rendering node.

According to one or more embodiments of the present disclosure, the present disclosure provides an image processing method, wherein the rendering node is a node that defines an algorithm type for rendering, and the rendering node is configured for instantiating a plurality of subclasses.

According to one or more embodiments of the present disclosure, the present disclosure provides an image processing method, wherein the rendering node is dynamically registered into the algorithm system as an independent algorithm to form the algorithm rendering composite system.

According to one or more embodiments of the present disclosure, the present disclosure provides an image processing method, wherein a specific process of rendering processing executed by the GPU is determined by a configured rendering engine.

According to one or more embodiments of the present disclosure, the present disclosure provides an image processing apparatus, including an image acquisition module for acquiring an image to be processed; an image processing module for inputting the image to be processed into an algorithm rendering composite system to obtain a processed image, wherein the algorithm rendering composite system is obtained by adding a rendering node to an algorithm system, and the rendering node is configured to render an image input to the rendering node; and an image rendering module for sending the processed image to a rendering system to render the processed image by the rendering system.

According to one or more embodiments of the present disclosure, the present disclosure provides an image processing apparatus including:
a memory; and
a processor coupled to the memory, the processor configured to perform any one of the aforementioned image processing methods based on instructions stored in the memory.

According to one or more embodiments of the present disclosure, the present disclosure provides an image processing system including:
any of the aforementioned image processing apparatuses; and
an algorithm rendering composite system including an algorithm node and a rendering node.

According to one or more embodiments of the present disclosure, the present disclosure provides an image processing system, wherein the operation of the rendering node rendering the image input to the rendering node is executed by a Graphics Processing Unit (GPU).

According to one or more embodiments of the present disclosure, the present disclosure provides an image processing system, wherein the algorithm rendering composite system includes an algorithm node and the rendering node connected according to a set relationship, and the set relationship is a sequential dependency relationship between the algorithm node and the rendering node determined by a graph configuration.

According to one or more embodiments of the present disclosure, the present disclosure provides an image processing system, wherein the algorithm node is configured to run an algorithm on the image input to the algorithm node, and the operation of the algorithm node running an algorithm on the image input to the algorithm node is executed by a Central Processing Unit (CPU).

According to one or more embodiments of the present disclosure, the present disclosure provides an image processing system, wherein the rendering node is configured to, after rendering the image input to the rendering node, convert a rendered image texture into an algorithm representation, and send the algorithm representation to an algorithm node connected with the rendering node or to a rendering node.

According to one or more embodiments of the present disclosure, the present disclosure provides an image processing system, wherein the rendering node is a node that defines an algorithm type for rendering, and the rendering node is configured for instantiating a plurality of subclasses.

According to one or more embodiments of the present disclosure, the present disclosure provides an image processing system, wherein the rendering node is dynamically registered into the algorithm system as an independent algorithm to form the algorithm rendering composite system.

According to one or more embodiments of the present disclosure, the present disclosure provides an image processing system, wherein a specific process of rendering processing executed by the GPU is determined by a configured rendering engine.

According to one or more embodiments of the present disclosure, the present disclosure provides an image processing system, further including a rendering system.

According to one or more embodiments of the present disclosure, the present disclosure provides a computer-readable storage medium on which a computer program is stored, which, when executed by a processor, implements any of the image processing methods provided by the present disclosure.

The embodiment of the present disclosure also provides a computer program product, which includes a computer program or instructions that, when executed by a processor, implement the image processing method as described above.

The embodiment of the present disclosure also provides a computer program, including:
instructions that, when executed by a processor, cause the processor to perform any one of the aforementioned image processing methods.

It will be appreciated by those skilled in the art that the scope of disclosure of the present disclosure is not limited to the technical solutions formed by specific combinations of the above-described technical features, and should also encompass other technical solutions formed by any combination of the above-described technical features or equivalents thereof without departing from the concept of the present disclosure. For example, the technical solutions formed by the above features be replaced with (but not limited to) features having similar functions disclosed in the present disclosure.

Further, although operations are depicted in a particular order, this should not be understood as requiring such operations to be performed in the particular order shown or in sequential order. Under certain circumstances, multitasking and parallel processing may be advantageous. Likewise, although several specific implementation details are included in the above discussion, these should not be construed as limitations on the scope of the present disclosure. Certain features that are described in the context of a single embodiment can also be implemented in combination in the single embodiment. Conversely, various features that are described in the context of a single embodiment can also be implemented in multiple embodiments separately or in any suitable subcombination.

Although the present subject matter has been described in language specific to structural features and/or methodological acts, it is to be understood that the subject matter defined in the appended claims is not necessarily limited to the specific features or acts described above. Rather, the specific features and acts described above are disclosed as example forms for implementing the claims.

1. An image processing method, comprising:
acquiring an image to be processed;
inputting the image to be processed into an algorithm rendering composite system to obtain a processed image, wherein the algorithm rendering composite system is obtained by adding a rendering node to an algorithm system, and the rendering node is configured to render an image input to the rendering node; and
sending the processed image to a rendering system to render the processed image by the rendering system.

2. The image processing method according to claim 1, wherein the operation of the rendering node rendering the image input to the rendering node is executed by a Graphics Processing Unit (GPU).

3. The image processing method according to claim 1, wherein the algorithm rendering composite system includes an algorithm node and the rendering node connected according to a set relationship, and the set relationship is a sequential dependency relationship between the algorithm node and the rendering node determined by a graph configuration.

4. The image processing method according to claim 3, wherein the algorithm node is configured to run an algorithm on the image input to the algorithm node, and the operation of the algorithm node running an algorithm on the image input to the algorithm node is executed by a Central Processing Unit (CPU).

5. The image processing method according to claim 1, wherein the rendering node is configured to, after rendering the image input to the rendering node, convert a rendered image texture into an algorithm representation, and send the algorithm representation to an algorithm node connected with the rendering node or to a rendering node.

6. The image processing method according to claim 1, wherein the rendering node is a node that defines an algorithm type for rendering, and the rendering node is configured for instantiating a plurality of subclasses.

7. The image processing method according to claim 1, wherein the rendering node is dynamically registered into the algorithm system as an independent algorithm to form the algorithm rendering composite system.

8. The image processing method according to claim 2, wherein a specific process of rendering processing executed by the GPU is determined by a configured rendering engine.

9. (canceled)

10. An image processing apparatus, comprising:
a memory; and
at least one processor coupled to the memory, the processor configured to, based on instructions stored in the memory, perform an image processing method comprising:
acquiring an image to be processed;
inputting the image to be processed into an algorithm rendering composite system to obtain a processed image, wherein the algorithm rendering composite system is obtained by adding a rendering node to an algorithm system, and the rendering node is configured to render an image input to the rendering node; and
sending the processed image to a rendering system to render the processed image by the rendering system.

11. An image processing system comprising:
the image processing apparatus according to claim 10; and
an algorithm rendering composite system including an algorithm node and a rendering node.

12. The image processing system according to claim 11, wherein the operation of the rendering node rendering the image input to the rendering node is executed by a Graphics Processing Unit (GPU).

13. The image processing system according to claim 11, wherein the algorithm rendering composite system includes an algorithm node and the rendering node connected according to a set relationship, and the set relationship is a sequential dependency relationship between the algorithm node and the rendering node determined by a graph configuration.

14. The image processing system according to claim 13, wherein the algorithm node is configured to run an algorithm on the image input to the algorithm node, and the operation of the algorithm node running an algorithm on the image input to the algorithm node is executed by a Central Processing Unit (CPU).

15. The image processing system according to claim 11, wherein the rendering node is configured to, after rendering the image input to the rendering node, convert a rendered image texture into an algorithm representation, and send the algorithm representation to an algorithm node connected with the rendering node or to the rendering node.

16. The image processing system according to claim 11, wherein the rendering node is a node that defines an algorithm type for rendering, and the rendering node is configured for instantiating a plurality of subclasses.

17. The image processing system according to claim 11, wherein the rendering node is dynamically registered into the algorithm system as an independent algorithm to form the algorithm rendering composite system.

18. The image processing system according to claim 11, wherein a specific process of rendering processing executed by the GPU is determined by a configured rendering engine.

19. The image processing system according to claim 11, further comprising:
a rendering system.

20. A non-transitory computer-readable storage medium having a computer program stored thereon, wherein the program, when executed by at least one processor, implements an image processing method comprising:
acquiring an image to be processed;
inputting the image to be processed into an algorithm rendering composite system to obtain a processed image, wherein the algorithm rendering composite system is obtained by adding a rendering node to an algorithm system, and the rendering node is configured to render an image input to the rendering node; and
sending the processed image to a rendering system to render the processed image by the rendering system.

21-22. (canceled)

23. The non-transitory computer-readable storage medium according to claim 20, wherein the operation of the rendering node rendering the image input to the rendering node is executed by a Graphics Processing Unit (GPU).
